(19) United States
(12) Patent Application Publication
(10) Pub. No.: US 2012/0281080 A1
(43) Pub. Date: Nov. 8, 2012

(54) USER BEHAVIOR TRACING METHOD, APPARATUS AND SYSTEM USED IN TOUCH SCREEN TERMINALS

(76) Inventor: Shouyu WANG, Shenzhen (CN)

(21) Appl. No.: 13/462,259

(22) Filed: May 2, 2012

Related U.S. Application Data
(63) Continuation of application No. PCT/CN2011/073692, filed on May 5, 2011.

(51) Int. Cl. H04N 7/18; G06F 3/041

(52) U.S. Cl. 348/77; 345/173; 348/E07.085

(57) ABSTRACT

A user behavior tracing method for a touch screen terminal includes capturing display content of a touch screen of the touch screen terminal through snapshotting, and capturing, through a sensing element of the touch screen, a coordinate corresponding to an operating behavior that is performed on the display content by a user; and outputting information of the captured display content of the touch screen and information of the captured coordinate corresponding to the operating behavior that is performed on the display content by the user.

### CROSS-REFERENCE TO RELATED APPLICATIONS

This application is a continuation of International Application No. PCT/CN2011/073692, filed on May 5, 2011, which is hereby incorporated by reference in their entireties.

### FIELD OF THE INVENTION

The present invention relates to the field of communications technologies, and more particularly to a user behavior tracing method, apparatus and system used in a touch screen of a terminal.

### BACKGROUND OF THE INVENTION

With electronic products being widely integrated with people's life, usability, as an important property of the products, gains more and more attention. The usability of an electronic product directly influences user experience of the product. In order to guarantee the usability of a product, a usability test is an inevitable process. The usability test refers to that, a group of representative users try out typical operations on the product, and at the same time, observers and developers observe, listen and record aside. Through the usability test, differences between a design solution and a psychology model of the users are checked to determine a usability problem.

In order to prevent an operating behavior activity of a user on the product from being disturbed by an external factor in the usability test, the operating behavior of the user on the product is usually traced and recorded by using a manner such as camera, so that the observers and developers make further study. Usually, a camera device may be installed in a test environment, installed on the test product or fixed on the test user.

Installation and debugging of the camera device are complex, which increases user behavior tracing difficulty. In addition, as regards a specific installation position of the camera device, it is hard to take tracing effects of various users into account. For example, a camera device installed in the test environment cannot effectively trace a detailed operating behavior of the user on the product, a facial expression of the user, and so on. Camera devices installed on the test product and the test user are capable of easily tracing the detailed operating behavior of the user on the product, the facial expression of the user, and so on, but may disturb the operating behavior of the user on the product, failing to ensure that the user operates the product at a most natural operating state and operating environment. In addition, if the camera device is installed on the test user, user comfort of using the product is decreased. As a result, the operating behavior performed by the user cannot demonstrate a real operating state of the product, and a user behavior tracing performance is poor.

### SUMMARY OF THE INVENTION

Embodiments of the present invention provide a user behavior tracing method, apparatus and system used in a touch screen terminal, which are capable of effectively reducing a user behavior tracing difficulty while ensuring a user behavior tracing performance.

In order to achieve the preceding objectives, embodiments of the present invention adopt the following technical solutions:

A user behavior tracing method used in a touch screen terminal, including:

capturing display content of a touch screen of the touch screen terminal through snapshotting, and capturing, through a sensing element of the touch screen, a coordinate corresponding to an operating behavior that is performed on the display content by a user; and

outputting information of the captured display content of the touch screen and information of the coordinate corresponding to the operating behavior that is performed on the display content by the user.

A user behavior tracing method used in a touch screen terminal, including:

receiving information of display content of a touch screen of the touch screen terminal and information of a coordinate corresponding to an operating behavior that is performed on the display content by a user; and

simulating, according to the information of the display content of the touch screen of the touch screen terminal and the information of the coordinate corresponding to the operating behavior that is performed on the display content by the user, the operating behavior that is performed on the display content by the user.

A user behavior tracing apparatus used in a touch screen terminal, including:

a screen capturing unit, configured to capture display content of a touch screen of the touch screen terminal through snapshotting;

an operation capturing unit, configured to capture, through a sensing element of the touch screen, a coordinate corresponding to an operating behavior that is performed on the display content by a user; and

an outputting unit, configured to output information of the captured display content of the touch screen and information of the coordinate corresponding to the operating behavior that is performed on the display content by the user.

A user behavior tracing apparatus used in a touch screen terminal, including:

a receiving unit, configured to receive information of display content of a touch screen of the touch screen terminal and information of a coordinate corresponding to an operating behavior that is performed on the display content by a user; and

a simulating unit, configured to simulate, according to the information of the display content of the touch screen of the touch screen terminal and the information of the coordinate corresponding to the operating behavior that is performed on the display content by the user, the operating behavior that is performed on the display content by the user.

A user behavior tracing system used in a touch screen terminal, including:

a first user behavior tracing apparatus and a second user behavior tracing apparatus;

where the first user behavior tracing apparatus is configured to capture display content of a touch screen of the touch screen terminal through snapshotting, capture, through a sensing element of the touch screen, a coordinate corresponding to an operating behavior that is performed on the display content by a user, and output information of the captured display content of the touch screen and information of the coordinate corresponding to the operating behavior that is performed on the display content by the user to the second user behavior tracing apparatus; and

the second user behavior tracing apparatus is configured to receive the information of the display content of the touch screen of the touch screen terminal and the information of the coordinate corresponding to the operating behavior that is performed on the display content by the user, and simulate, according to the information of the display content of the touch screen of the touch screen terminal and the information of the coordinate corresponding to the operating behavior that is performed on the display content by the user, the operating behavior that is performed on the display content by the user.

According to the user behavior tracing method, apparatus and system of the touch screen terminal provided in the embodiments of the present invention, the display content of the touch screen of the touch screen terminal is captured through snapshotting, and the coordinate corresponding to the operating behavior that is performed on the display content by the user is captured through the sensing element of the touch screen, thereby fully utilizing an apparatus already existing in the touch screen terminal. No additional apparatus for tracing a user behavior is installed on the touch screen terminal or the user, which not only saves installation and debugging of an additional apparatus, but also accurately records and simulates the operating behavior of the user on the touch screen terminal under a condition that the user operating behavior is not disturbed and that the user is in a natural operating state and operating environment is ensured, thereby effectively reducing the user behavior tracing difficulty while ensuring the user behavior tracing performance.

### BRIEF DESCRIPTION OF THE DRAWINGS

To illustrate the technical solutions according to the embodiments of the present invention or in the prior art more clearly, the accompanying drawings required for describing the embodiments or the prior art are introduced below briefly. Apparently, the accompanying drawings in the following descriptions merely show some of the embodiments of the present invention, and persons of ordinary skill in the art can obtain other drawings according to the accompanying drawings without creative efforts.

FIG. 1 is a flow chart of a user behavior tracing method used in a touch screen terminal according to an embodiment of the present invention;

FIG. 2 is another flow chart of a user behavior tracing method used in a touch screen terminal according to an embodiment of the present invention;

FIG. 3 is a simulation schematic diagram of a user operating behavior in a user behavior tracing method used in a touch screen terminal according to an embodiment of the present invention;

FIG. 4 is another simulation schematic diagram of a user operating behavior in a user behavior tracing method used in a touch screen terminal according to an embodiment of the present invention;

FIG. 5 is a simulation schematic diagram of an operating behavior that is performed on display content by a user in a user behavior tracing method used in a touch screen terminal according to an embodiment of the present invention;

FIG. 6 is a schematic structural diagram of a user behavior tracing apparatus used in a touch screen terminal according to an embodiment of the present invention;

FIG. 7 is another schematic structural diagram of a user behavior tracing apparatus used in a touch screen terminal according to an embodiment of the present invention;

FIG. 8 is another schematic structural diagram of a user behavior tracing apparatus used in a touch screen terminal according to an embodiment of the present invention; and

FIG. 9 is a schematic structural diagram of a user behavior tracing system used in a touch screen terminal according to an embodiment of the present invention.

### DETAILED DESCRIPTION OF THE EMBODIMENTS

The technical solutions of the present invention will be clearly and fully described in the following with reference to the accompanying drawings.

It should be noted that the embodiments to be described are only a part rather than all of the embodiments of the present invention. All other embodiments obtained by persons skilled in the art based on the embodiments of the present invention without creative efforts shall fall within the protection scope of the present invention.

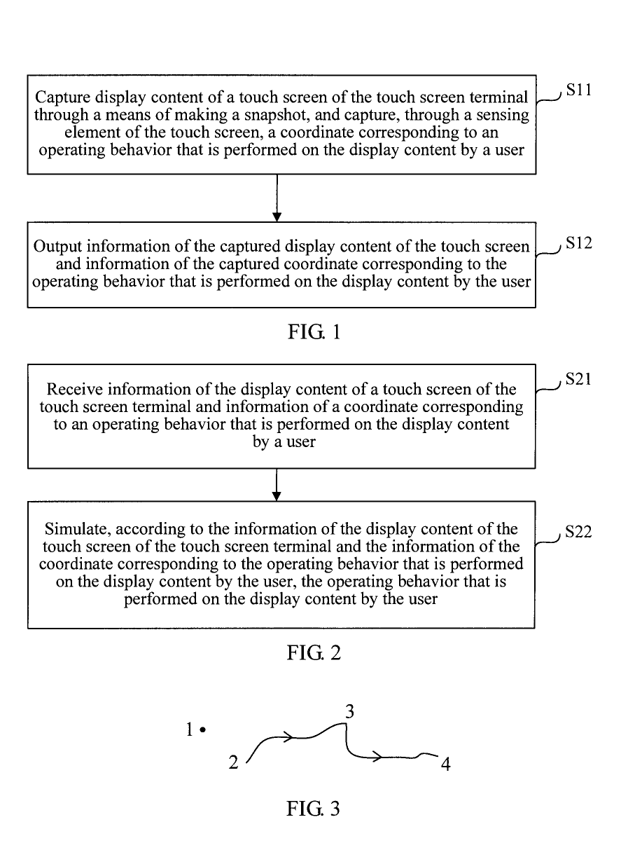

As shown in FIG. 1, an embodiment of the present invention provides a user behavior tracing method used in a touch screen terminal, which is based on a user behavior tracing apparatus installed on the touch screen terminal and includes the following:

S11: Capture display content of a touch screen of the touch screen terminal through snapshotting, and capture, through a sensing element of the touch screen, a coordinate corresponding to an operating behavior that is performed on the display content by a user.

The display content of the touch screen may be captured through snapshotting, which is beneficial to subsequent data processing and usability analysis.

The operating behavior that is performed on the display content by the user includes that the user clicks and/or slides on the display content of the touch screen. Usually, when the user performs a clicking operation on the display content of the touch screen, the user touches the touch screen with a finger and then lifts the finger. At this time, a coordinate corresponding to the clicking of the user on the display content of the touch screen is a coordinate corresponding to a position touched by the finger of the user, for example (x, y). When the user performs a sliding operation on the display content of the touch screen, the user touches the touch screen and performs relative sliding with the finger. At this time, a coordinate corresponding to the sliding of the user on the display content of the touch screen is a coordinate set of all points on a sliding track of the user finger, or a coordinate set of specified points that are capable of representing the sliding track. For example, coordinates of the points on the sliding track are (x1, y1), (x2, y2), (x3, y3) . . . in sequence.

S12: Output information of the captured display content of the touch screen and information of the coordinate corresponding to the operating behavior that is performed on the display content by the user.

In this step, the information of the display content of the touch screen captured in step S11 and the information of the coordinate that corresponds to the operating behavior performed on the display content by the user and is captured in step S11 are sent to a remote user behavior tracing apparatus, so that the remote user behavior tracing apparatus simulates, according to the information of the captured display content of the touch screen and the information of the coordinate corresponding to the operating behavior that is performed on the display content by the user, the operating behavior that is performed on the display content by the user, so as to perform a usability analysis on the touch screen terminal.

In this step, the information of the display content of the touch screen captured in step S11 and the information of the coordinate that corresponds to the operating behavior performed on the display content by the user and is captured in step S11 are sent to the remote user behavior tracing apparatus, where the remote user behavior tracing apparatus is an apparatus set outside the touch screen terminal. The remote user behavior tracing apparatus processes the information. In this way, the user behavior tracing process does not occupy resources of the touch screen terminal, thus reducing influences on performance of the touch screen terminal. Therefore, when the user operates the touch screen terminal, a normal working state of the touch screen terminal is able to be ensured, so that the operating behavior of the user is capable of truly and accurately reflecting experience of using the touch screen terminal.

The remote user behavior tracing apparatus may be set at any position in a test environment of the touch screen terminal, or set outside the test environment. Preferably, the remote user behavior tracing apparatus is set outside the test environment, to avoid interference on the operating behavior of the user. The user behavior tracing apparatus set at the touch screen terminal records the operating behavior of the user, while the remote user behavior tracing apparatus processes information of the operating behavior. The two user behavior tracing apparatuses are physically separated but are interconnected in terms of information, which not only protects the user from external interference and achieves an almost natural using state of the product, but also traces a user behavior more comprehensively, thereby reducing a user behavior tracing difficulty for the touch screen terminal while ensuring a user behavior tracing performance.

Preferably, in this step, the information of the captured display content of the touch screen and the information of the coordinate corresponding to the operating behavior that is performed on the display content by the user may be sent to the remote user behavior tracing apparatus through a wireless channel. By using the wireless channel outputting manner, the user may move freely when using the touch screen terminal without being limited by a wired connection, so that the user is closer to the natural using state, which effectively ensures the correctness and value of the captured information, and also effectively ensures the user behavior tracing performance. This wireless channel outputting manner is more applicable to the user behavior tracing of a handheld touch screen mobile terminal. In this step, the information of the captured display content of the touch screen and the information of the coordinate corresponding to the operating behavior that is performed on the display content by the user may also be sent to the remote user behavior tracing apparatus through a wired channel.

For example, for the touch screen terminal, the display content of the touch screen is P1 during a time segment from t1 to t2, and the clicking and sliding of the user finger on the touch screen are directed to P1. At the time t2, after the user clicks a point of P1 with the finger, a new window pops up on the screen, to change the current display content of the screen, and the display content of the screen is P2 at this time. Operations of the user finger on the touch screen after the time t2 are all directed to P2. In step S11, P1 and P2 are captured through snapshotting, and a coordinate corresponding to the operating behavior that is performed on P1 by the user and a coordinate corresponding to the operating behavior that is performed on P2 by the user are captured through the sensing element of the touch screen respectively. In step S12, P1 and P2, as well as the coordinate corresponding to the operating behavior on P1 and the coordinate corresponding to the operating behavior that is performed on P2 by the user are sent out.

In the user behavior tracing method of the touch screen terminal provided in this embodiment of the present invention, the display content of the touch screen of the touch screen terminal is captured by snapshotting, and the coordinate corresponding to the operating behavior performed on the display content by the user is captured through the sensing element of the touch screen. Taking the user behavior tracing of a touch screen mobile phone as an example, according to the user behavior tracing method provided in this embodiment, common operations when the user uses the touch screen mobile phone, such as menu pop-up, text input, entertainment activities and other operations, are able to be recorded in a most direct manner through a touch screen sensing manner, and accurate and clear screen display content corresponding to each user operating behavior is captured by snapshotting. In this way, in the user behavior tracing method provided in this embodiment of the present invention, the apparatus already existing in the touch screen terminal is fully utilized, and no additional apparatus for tracing the user behavior is installed on the touch screen terminal or the user, which not only saves installation and debugging of an additional apparatus, but also accurately records and simulates the operating behavior of the user on the touch screen terminal under a condition that the user operating behavior is not disturbed and that the user is in a natural operating state and operating environment is ensured, thereby effectively reducing the user behavior tracing difficulty while ensuring the user behavior tracing performance.

Furthermore, the user behavior tracing method provided in this embodiment further includes:

collecting video information of the user operating behavior through a video recording apparatus set on the touch screen terminal and/or collecting audio information of the user operating behavior through an audio recording apparatus set on the touch screen terminal; and

outputting the collected video information and/or audio information.

The video information of the user operating behavior mainly refers to body languages, such as a facial expression of the user, and the audio information of the user operating behavior mainly refers to language formulation of the user.

In this way, in the user behavior tracing method provided in this embodiment of the present invention, a facial expression, an action, a speech, an emotion, and so on of the user in a process of using the device or terminal is further able to be traced, thereby tracing the user behavior more comprehensively and ensuring the user behavior tracing performance, so as to more objectively and comprehensively reflect a usability problem of the touch screen terminal.

Specifically, the video information of the user may be collected through a camera set on the touch screen terminal, and/or the audio information of the user is collected through a microphone set on the touch screen terminal. In this way, as the touch screen terminal is in a range within the reach of the user, and a distance between the camera and the user is appropriate, which is applicable to video collecting, the collected video information such as the facial expression and the action of the user is capable of directly reflecting an operating satisfaction degree of the user on the touch screen terminal. On the other hand, as the camera and the microphone are both accessory equipments of the touch screen terminal, using the camera and the microphone to record the action and the speech of the user does not affect a normal operation of the user on the touch screen terminal, therefore further reducing the user behavior tracing difficulty. Correspondingly, the touch screen terminal also outputs the video information and/or the audio information to the remote user behavior tracing apparatus, so that the remote user behavior tracing apparatus analyzes and processes various recorded information.

Specifically, the collected video and/or audio information may also be sent to the remote user behavior tracing apparatus through a wireless channel or a wired channel, and optimally, through a wireless channel.

Corresponding to the method shown in FIG. 1, as shown in FIG. 2, an embodiment of the present invention further provides a user behavior tracing method used in a touch screen terminal, which is based on the preceding remote user behavior tracing apparatus and includes the following:

S21: Receive information of display content of a touch screen of the touch screen terminal and information of a coordinate corresponding to an operating behavior performed on the display content by a user.

Specifically, the information of the display content of the touch screen of the touch screen terminal and the information of the coordinate corresponding to the operating behavior that is performed on the display content by the user may be received through a wired channel or a wireless channel.

S22: Simulate, according to the information of the display content of the touch screen of the touch screen terminal and the information of the coordinate corresponding to the operating behavior that is performed on the display content by the user, the operating behavior that is performed on the display content by the user.

Optionally, in this step, the information of the display content of the touch screen of the touch screen terminal and the information of the coordinate corresponding to the operating behavior that is performed on the display content by the user are combined, and the coordinate corresponding to the operating behavior that is performed on the display content by the user is demonstrated on the display content by using chronological points and/or a chronological line.

The operating behavior that is performed on the display content by the user may first be demonstrated by using chronological points and/or a chronological line according to the information of the coordinate corresponding to the operating behavior that is performed on the display content by the user, and then be combined with the corresponding display content corresponding to the operating behavior performed by the user on the display content. Alternatively, the operating behavior of the user performed on the display content may also be directly demonstrated on the display content by using chronological points and/or a chronological line according to the information of the coordinate corresponding to the operating behavior that is performed on the display content by the user.

For example, as shown in FIG. 3, a point is used to represent the clicking of the user on the display content of the touch screen, and a line is used to represent a sliding track of the user on the touch screen, where an arrow on the line indicates a direction of the sliding operation of the user. In order to accurately reflect a time sequence of user operations, in this embodiment, a number label is marked on a point or the line. An operating behavior of the user shown in FIG. 3 represents that, the user first clicks position 1, then slides from position 2 to position 3, and then slides from position 3 to position 4. Definitely, in order to clearly display an operating path of the user, different colors of points or lines may be adopted. In this way, operating behaviors that are performed on the display content by the user is simulated, and then in combination with bearing objects of these operating behaviors, that is, screen display content corresponding to the operating behaviors, the operating behaviors that are performed on the display content of the touch screen terminal by the user is able to be completely simulated.

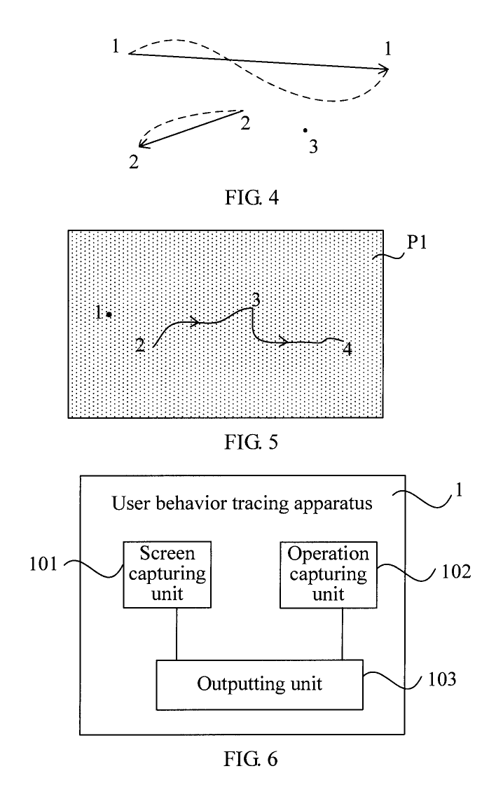

Optionally, as shown in FIG. 4, during the process of demonstrating, by using the chronological points and/or the chronological line, the operating behavior that is performed on the display content by the user, the sliding track of the user finger on the touch screen may be neglected while directly presenting an initial position and a final position of the sliding of the user finger on the touch screen through a directional line segment, where the initial position refers to a position on the touch screen where the user presses the finger, and the final position refers to a position on the touch screen where the user lifts the finger. Dashed lines in FIG. 4 are actual sliding tracks of the user finger, which are not displayed in the processing of this step, and solid lines with arrows indicate an operating process of the user, which is displayed in the processing of this step. Optimally, a number label may be used to mark a time sequence of a change of a position corresponding to each sliding action of the user. User actions shown in FIG. 4 are performing a sliding operation 1-1 first, and then performing a sliding operation 2-2, where sliding directions are shown by arrows in FIG. 4 respectively, and finally performing a clicking operation 3.

It should be noted that, in the present invention, the manner for demonstrating the operating behavior that is performed on the display content by the user is not limited thereto, and other demonstrating manners may also be adopted in the present invention.

In the same way, taking P1 and P2 in the embodiment shown in FIG. 1 as an example, in step S21, P1 and P2, as well as the coordinate corresponding to the operating behavior that is performed on P1 and the coordinate corresponding to the operating behavior that is performed on P2 by the user are received. In step S22, the coordinate corresponding to the operating behavior that is performed on P1 by the user is demonstrated on the display content P1 by using chronological points and/or a chronological line, and the coordinate corresponding to the operating behavior that is performed on P2 by the user is demonstrated on the display content P2 by using chronological points and/or a chronological line. It is assumed that FIG. 3 represents the user operating behavior that is performed on P1 by the user. In this case, after simulation, the user operating behavior that is performed on P1 by the user may be shown in FIG. 5.

It should be noted that, a core task of this step is simulating the user behavior according to the received information, so that the operating behavior of the user on the touch screen terminal is reproduced. A processing sequence of various information and the simulation method are not limited in the present information.

In the user behavior tracing method of the touch screen terminal provided in this embodiment of the present invention, the operating behavior of the user on the touch screen is accurately simulated according to the received information of the content display of the touch screen of the touch screen terminal and the received information of the coordinate corresponding to the operating behavior that is performed on the display content by the user, and demonstrated to an observer, so that the operating behavior of the user who uses the touch screen terminal in an almost natural state is vividly reproduced, thereby effectively reducing a user behavior tracing difficulty while ensuring a user behavior tracing performance.

Furthermore, the user behavior tracing method provided in this embodiment further includes:

receiving video information and/or audio information of the user operating behavior; and specifically, receiving the video information and/or the audio information of the user operating behavior through a wired or a wireless channel; and

combining the information of the display content of the touch screen of the touch screen terminal, the information of the coordinate corresponding to the operating behavior that is performed on the display content by the user, and the video information and/or the audio information of the user operating behavior, demonstrating, on the display content by using chronological points and/or a chronological line, the coordinate corresponding to the operating behavior that is performed on the display content by the user, and adding the video and/or audio information synchronously recording the operating behavior of the user.

In this way, in the user behavior tracing method provided in this embodiment of the present invention, the operating behavior of the user is able to be simulated more directly and comprehensively, so that an operation, an expression, a voice, an emotion, and so on of the user are able to be reproduced synchronously, thereby tracing the user behavior more accurately and comprehensively, effectively reducing the user behavior tracing difficulty, and ensuring the user behavior tracing performance. In addition, a usability problem of the touch screen terminal is able to be reflected more objectively and comprehensively, providing strong and accurate data support for a usability analysis on the touch screen terminal.

Corresponding to the aforementioned methods, as shown in FIG. 6, an embodiment of the present invention further provides a user behavior tracing apparatus 1 used in a touch screen terminal, including:

a screen capturing unit 101, configured to capture display content of a touch screen of the touch screen terminal through snapshotting;

an operation capturing unit 102, configured to capture, through a sensing element of the touch screen, a coordinate corresponding to an operating behavior that is performed on the display content by a user; and

an outputting unit 103, configured to output information of the captured display content of the touch screen and information of the coordinate corresponding to the operating behavior that is performed on the display content by the user.

The user behavior tracing apparatus used in the touch screen terminal provided in this embodiment of the present invention captures the display content of the touch screen of the touch screen terminal through snapshotting, and captures, through the sensing element of the touch screen, the coordinate corresponding to the operating behavior that is performed on the display content by the user, thereby fully utilizing an apparatus already existing in the touch screen terminal. No additional apparatus for tracing a user behavior is installed on the touch screen terminal or the user, which not only saves installation and debugging of an additional apparatus, but also accurately records and simulates the operating behavior of the user on the touch screen terminal under a condition that the user operating behavior is not disturbed and that the user is in a natural operating state and operating environment is ensured, thereby effectively reducing a user behavior tracing difficulty while ensuring a user behavior tracing performance.

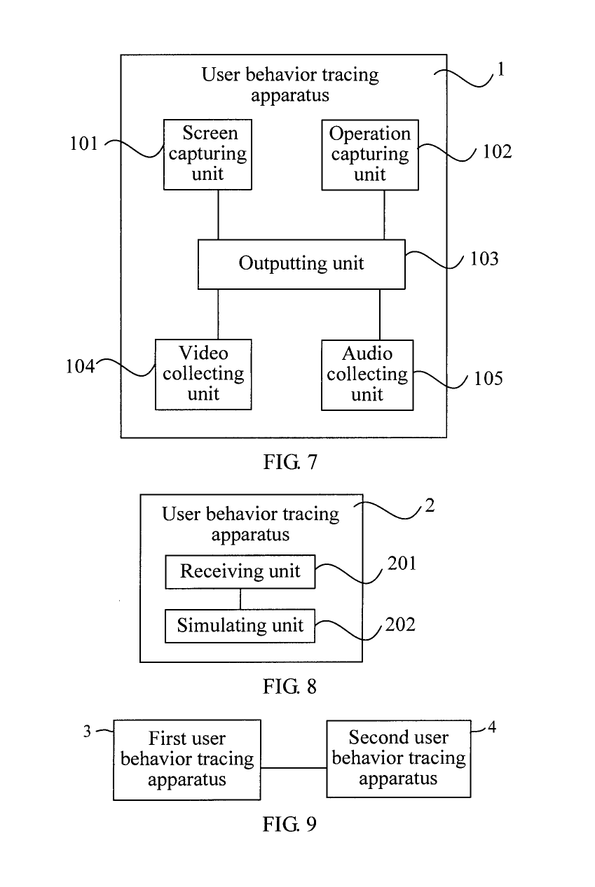

Furthermore, as shown in FIG. 7, the user behavior tracing apparatus used in the touch screen terminal further includes:

a video collecting unit 104, configured to collect video information of the user through a video recording apparatus set on the touch screen terminal;

an audio collecting unit 105, configured to collect audio information of the user through an audio recording apparatus set on the touch screen terminal; where

the outputting unit 103 is further configured to output the video information and/or the audio information. Accurate information of the user operating behavior in combination with expression and voice information of the user further reduces the user behavior tracing difficulty of the touch screen terminal.

Specifically, the outputting unit 103 of the user behavior tracing apparatus 1 provided in this embodiment is capable of outputting the information of the display content of the touch screen and the information of the coordinate corresponding to the operating behavior that is performed on the display content by the user through a wireless channel or a wired channel. In addition, the user may flexibly select an information outputting manner according to an actual situation, which further reduces the user behavior tracing difficulty of the touch screen terminal.

Correspondingly, as shown in FIG. 8, an embodiment of the present invention further provides a user behavior tracing apparatus 2 used in a touch screen terminal, including:

a receiving unit 201, configured to receive information of display content of a touch screen of the touch screen terminal and information of a coordinate corresponding to an operating behavior that is performed on the display content by a user;

a simulating unit 202, configured to simulate, according to the information of the display content of the touch screen of the touch screen terminal and the information of the coordinate corresponding to the operating behavior that is performed on the display content by the user, the operating behavior that is performed on the display content by the user.

The user behavior tracing apparatus of the touch screen terminal provided in this embodiment of the present invention accurately simulates, according to the received information of the content display of the touch screen of the touch screen terminal and the received information of the coordinate corresponding to the operating behavior that is performed on the display content by the user, the operating behavior that is performed on the touch screen by the user, and demonstrates the operating behavior that is performed on the touch screen by the user to an observer, so that the operating behavior of the user who uses the touch screen terminal in an almost natural state is vividly reproduced, thereby effectively reducing a user behavior tracing difficulty while ensuring a user behavior tracing performance.

Specifically, the receiving unit 201 is capable of receiving the information of the display content of the touch screen and the information of the coordinate corresponding to the operating behavior that is performed on the display content by the user through a wireless channel or a wired channel.

Specifically, the simulating unit 202 is specifically configured to combine the information of the display content of the touch screen of the touch screen terminal and the information of the coordinate corresponding to the operating behavior that is performed on the display content by the user, and demonstrate, on the display content by using chronological points and/or a chronological line, the coordinate corresponding to the operating behavior that is performed on the display content by the user.

Furthermore, the receiving unit 201 is further configured to receive video information and/or audio information of the user behavior, and specifically, receive the video information and/or the audio information of the user behavior through a wireless channel or a wired channel.

Furthermore, the simulating unit 202 is further specifically configured to combine the information of the display content of the touch screen of the touch screen terminal, the information of the coordinate corresponding to the operating behavior that is performed on the display content by the user, and the video information and/or the audio information of the user operating behavior, demonstrate, on the display content by using chronological points and/or a chronological line, the coordinate corresponding to the operating behavior that is performed on the display content by the user, and add the video and/or audio information synchronously recording the operating behavior of the user.

Correspondingly, as shown in FIG. 9, an embodiment of the present invention further provides a user behavior tracing system used in a touch screen terminal, including a first user behavior tracing apparatus 3 and a second user behavior tracing apparatus 4,

where the first user behavior tracing apparatus 3 is configured to capture display content of a touch screen of the touch screen terminal through snapshotting, capture, through a sensing element of the touch screen, a coordinate corresponding to an operating behavior that is performed on the display content by a user, and output information of the captured display content of the touch screen and information of the captured coordinate corresponding to the operating behavior that is performed on the display content by the user to the second user behavior tracing apparatus 4; and

the second user behavior tracing apparatus 4 is configured to receive the information of the display content of the touch screen of the touch screen terminal and the information of the coordinate corresponding to the operating behavior that is performed on the display content by the user, and simulate, according to the information of the display content of the touch screen of the touch screen terminal and the information of the coordinate corresponding to the operating behavior that is performed on the display content by the user, the operating behavior that is performed on the display content by the user.

In the user behavior tracing system of the touch screen terminal provided in this embodiment of the present invention, the first user behavior tracing apparatus 3 captures the display content of the touch screen of the touch screen terminal through snapshotting, and captures, through the sensing element of the touch screen, the coordinate corresponding to the operating behavior that is performed on the display content by the user. The second user behavior tracing apparatus 4 processes the information captured by the first user behavior tracing apparatus 3, and simulates the operating behavior of the user. In this way, an apparatus already existing in the touch screen terminal is fully utilized, and no additional apparatus for tracing the user behavior is installed on the touch screen terminal or the user, which not only saves installation and debugging of an additional apparatus, but also accurately records and simulates the operating behavior of the user on the touch screen terminal under a condition that the user operating behavior is not disturbed and that the user is in a natural operating state and operating environment is ensured, thereby effectively reducing a user behavior tracing difficulty while ensuring a user behavior tracing performance.

The user behavior tracing apparatus 1 provided in the embodiment of the present invention may be adopted as the first user behavior tracing apparatus 3, and the user behavior tracing apparatus 2 provided in the embodiment of the present invention may be adopted as the second user behavior tracing apparatus 4, which is described in detail above, and is not described herein again.

Persons of ordinary skill in the art may understand that all or a part of the processes of the methods according to the embodiments of the present invention may be implemented by a program instructing relevant hardware. The program may be stored in a computer readable storage medium. When the program runs, the steps of the methods according to the embodiments of the present invention are performed. The storage medium includes any medium that is capable of storing program codes, such as a ROM, a RAM, a magnetic disk, or a CD-ROM.

The preceding describes only specific implementation manners of the present invention, but the protection scope of the present invention is not limited herein. Any change or replacement that can be easily figured out by persons skilled in the art within the technical scope disclosed by the present invention shall be covered by the protection scope of the present invention. Therefore, the protection scope of the present invention shall be the protection scope of the claims.

What is claimed is:

1. A user behavior tracing method used for a touch screen terminal, comprising:
capturing display content of a touch screen of the touch screen terminal, and capturing, through a sensing element of the touch screen, a coordinate corresponding to an operating behavior that is performed on the display content by a user; and
outputting information of the captured display content of the touch screen and information of the captured coordinate corresponding to the operating behavior that is performed on the display content by the user.

2. The user behavior tracing method according to claim 1, wherein the operating behavior that is performed on the display content by the user comprises clicking the display content by the user and/or sliding on the display content by the user.

3. The user behavior tracing method according to claim 1, wherein the method further comprises:
collecting video information of the user operating behavior through a video recording apparatus set on the touch screen terminal and/or collecting audio information of the user operating behavior through an audio recording apparatus set on the touch screen terminal; and
outputting the collected video information and/or audio information.

4. The user behavior tracing method according to claim 1, wherein a manner for outputting the information specifically comprises: outputting the information through a wireless channel or a wired channel.

5. A user behavior tracing method used in a touch screen terminal, comprising:
receiving information of display content of a touch screen of the touch screen terminal and information of a coordinate corresponding to an operating behavior that is performed on the display content by a user; and
simulating, according to the information of the display content of the touch screen of the touch screen terminal and the information of the coordinate corresponding to the operating behavior that is performed on the display content by the user, the operating behavior that is performed on the display content by the user.

6. The user behavior tracing method according to claim 5, wherein the simulating, according to the information of the display content of the touch screen of the touch screen terminal and the information of the coordinate corresponding to the operating behavior that is performed on the display content by the user, the operating behavior that is performed on the display content by the user comprises:
combining the information of the display content of the touch screen of the touch screen terminal and the information of the coordinate corresponding to the operating behavior that is performed on the display content by the user, and demonstrating, on the display content by using chronological points and/or a chronological line, the coordinate corresponding to the operating behavior that is performed on the display content by the user.

7. The user behavior tracing method according to claim 5, wherein the method further comprises:
receiving video information and/or audio information of the user operating behavior; and
combining the information of the display content of the touch screen of the touch screen terminal, the information of the coordinate corresponding to the operating behavior that is performed on the display content by the user, and the video information and/or the audio information of the user operating behavior, demonstrating, on the display content by using chronological points and/or a chronological line, the coordinate corresponding to the operating behavior that is performed on the display content by the user, and adding the video and/or the audio information synchronously recording the operating behavior of the user.

8. The user behavior tracing method according to claim 5, wherein a manner for receiving the information comprises: receiving the information through a wireless channel or a wired channel.

9. The user behavior tracing method used for a touch screen terminal, wherein the capturing display content of a touch screen of the touch screen terminal comprises capturing display content of a touch screen of the touch screen terminal through snapshotting.

10. A user behavior tracing apparatus used for a touch screen terminal, comprising:
a screen capturing unit, configured to capture display content of a touch screen of the touch screen terminal;
an operation capturing unit, configured to capture, through a sensing element of the touch screen, a coordinate corresponding to an operating behavior that is performed on the display content by a user; and
an outputting unit, configured to output information of the captured display content of the touch screen and information of the captured coordinate corresponding to the operating behavior that is performed on the display content by the user.

11. The user behavior tracing method according to claim 10, wherein the operating behavior that is performed on the display content by the user comprises clicking the display content by the user and/or sliding on the display content by the user that is captured by the operation capturing unit.

12. The user behavior tracing apparatus according to claim 10, further comprising:
a video collecting unit, configured to collect video information of the user operating behavior through a video recording apparatus set on the touch screen terminal;
and/or
an audio collecting unit, configured to collect audio information of the user operating behavior through an audio recording apparatus set on the touch screen terminal; wherein the outputting unit is further configured to output the video information collected by the video recording apparatus and/or the audio information collected by the audio recording apparatus.

13. The user behavior tracing apparatus according to claim 10, wherein the outputting unit is specifically configured to output the information through a wireless channel or a wired channel.

14. The user behavior tracing apparatus used for a touch screen terminal of claim 10, wherein the screen capturing unit is configured to capture display content of a touch screen of the touch screen terminal through snapshotting.

15. A user behavior tracing apparatus used in a touch screen terminal, comprising:
a receiving unit, configured to receive information of display content of a touch screen of the touch screen terminal and information of a coordinate corresponding to an operating behavior that is performed on the display content by a user; and
a simulating unit, configured to simulate, according to the information of the display content of the touch screen of the touch screen terminal and the information of the coordinate corresponding to the operating behavior that is performed on the display content by the user, the operating behavior that is performed on the display content by the user.

16. The user behavior tracing apparatus according to claim 15, wherein the simulating unit is specifically configured to combine the information of the display content of the touch screen of the touch screen terminal and the information of the coordinate corresponding to the operating behavior that is performed on the display content by the user, and demonstrate, on the display content by using chronological points and/or a chronological line, the coordinate corresponding to the operating behavior that is performed on the display content by the user.

17. The user behavior tracing apparatus according to claim 15, wherein:
the receiving unit is further configured to receive video information and/or audio information of the user behavior; and
the simulating unit is further configured to combine the information of the display content of the touch screen of the touch screen terminal, the information of the coordinate corresponding to the operating behavior that is performed on the display content by the user, and the video information and/or the audio information of the user operating behavior, demonstrate, on the display content by using chronological points and/or a chronological line, the coordinate corresponding to the operating behavior that is performed on the display content by the user, and add the video and/or audio information synchronously recording the operating behavior of the user.

18. The user behavior tracing apparatus according to claim 15, wherein the receiving unit is specifically configured to receive the information through a wireless channel or a wired channel.

19. A user behavior tracing system used in a touch screen terminal, comprising a first user behavior tracing apparatus and a second user behavior tracing apparatus;
wherein the first user behavior tracing apparatus is configured to capture display content of a touch screen of the touch screen terminal through snapshotting, capture, through a sensing element of the touch screen, a coordinate corresponding to an operating behavior that is performed on the display content by a user, and output information of the captured display content of the touch screen and information of the captured coordinate corresponding to the operating behavior that is performed on the display content by the user to the second user behavior tracing apparatus; and
the second user behavior tracing apparatus is configured to receive the information of the display content of the touch screen of the touch screen terminal and the information of the coordinate corresponding to the operating behavior that is performed on the display content by the user, and simulate, according to the information of the display content of the touch screen of the touch screen terminal and the information of the coordinate corresponding to the operating behavior that is performed on the display content by the user, the operating behavior that is performed on the display content by the user.
